(19) United States
(12) Patent Application Publication
(10) Pub. No.: US 2010/0031087 A1
(43) Pub. Date: Feb. 4, 2010

(54) METHOD OF CONTROL IN A SYSTEM HAVING A MEDIA READER

(76) Inventors: Chiung-Chi LIN, Taipei City (TW); Yung-Shun KUAN, Taipei City (TW); Vincent HSU, Taipei City (TW); Shih-Hsuan LIN, Taipei City (TW); Shirley LIN, Taipei City (TW)

Correspondence Address: LADAS & PARRY LLP, 224 SOUTH MICHIGAN AVENUE, SUITE 1600, CHICAGO, IL, 60604, US

(21) Appl. No.: 12/418,696

(22) Filed: Apr. 6, 2009

(30) Foreign Application Priority Data
Aug. 1, 2008 (TW) 097129242

(51) Int. Cl. G06F 11/07; G06F 3/00; G06F 13/10

(52) U.S. Cl. 714/15; 710/11; 710/8; 714/E11.023; 710/300

(57) ABSTRACT

A method of control in a system, which includes a media reader and a host unit, includes configuring the host unit to detect whether the media reader is responding, and configuring the host unit to reset the media reader when it is detected that the media reader stops responding. A system that includes the media reader and the host unit is also disclosed.

### CROSS-REFERENCE TO RELATED APPLICATION

This application claims priority of Taiwanese Application No. 097129242, filed on Aug. 1, 2008.

### BACKGROUND OF THE INVENTION

1. Field of the Invention

This invention relates to a method of control in a system, more particularly to a method of control in a system that includes a media reader.

2. Description of the Related Art

Typically, a multimedia information service system, a.k.a., an interactive kiosk, provides information access, and services such as ticketing, image editing and sharing, e-mail, downloading, and printing.

FIG. 1 illustrates a conventional multimedia information service system 7 that includes a media reader 72 and a host unit 71. The media reader 72 into which an electronic card 711 is inserted reads information contained in the electronic card 711 and forwards the information read thereby to the host unit 71.

The aforementioned conventional multimedia information service system 7 is disadvantageous in that suppose the media reader 72 stops responding, e.g., due to improper insertion of the electronic card 711 thereinto. The user has to notify first service personnel. Then, the service personnel connect with the conventional multimedia information service system 7 via a remote terminal 9 over a network 8 and reset the media reader 72 to thereby restore the media reader 72 to its normal condition. This does not only cause inconvenience on the part of the user, but also takes up a considerable amount of time.

### SUMMARY OF THE INVENTION

Therefore, an object of the present invention is to provide a method of control that restores a malfunctioning media reader of a system to its normal condition without user intervention and within a short period of time.

Another object of the present invention is to provide a system that restores a malfunctioning media reader thereof to its normal condition without user intervention and within a short period of time.

According to an aspect of the present invention, a method of control in a system, which includes a media reader and a host unit, comprises configuring the host unit to detect whether the media reader is responding, and configuring the host unit to reset the media reader when it is detected that the media reader stops responding.

According to another aspect of the present invention, a system comprises a media reader and a host unit. The host unit is coupled to the media reader, and is operable so as to detect whether the media reader is responding, and so as to issue a reset command to the media reader, which resets the media reader, when it is detected thereby that the media reader stops responding.

### BRIEF DESCRIPTION OF THE DRAWINGS

Other features and advantages of the present invention will become apparent in the following detailed description of the preferred embodiments with reference to the accompanying drawings, of which:

FIG. 1 is a schematic block diagram of a conventional multimedia information service system connected to a remote terminal over a network;

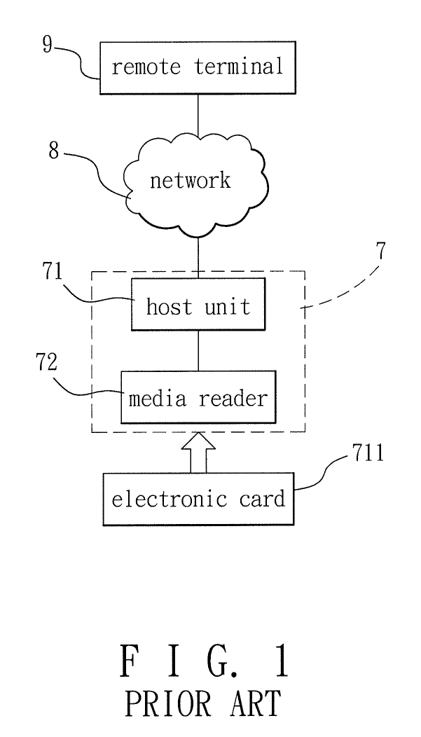

FIG. 2 is a schematic block diagram of the first preferred embodiment of a system according to this invention;

FIG. 3 is a flow chart of the preferred embodiment of a method of control in the system in FIG. 2 according to this invention; and

FIG. 4 is a schematic block diagram of the second preferred embodiment of a system according to this invention.

### DETAILED DESCRIPTION OF THE PREFERRED EMBODIMENTS

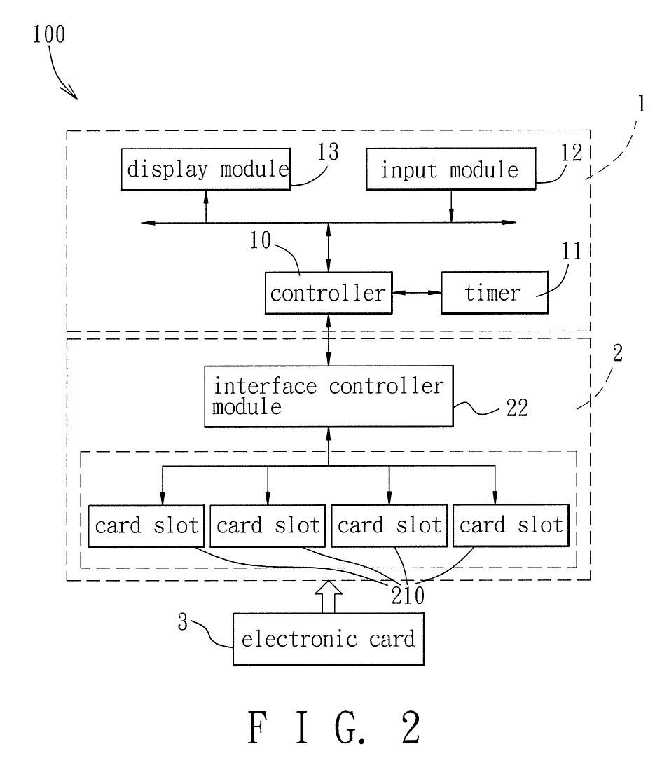

Referring to FIG. 2, the first preferred embodiment of a system 100 according to this invention is shown to include a media reader 2 and a host unit 1.

The system 100 of this invention is a multimedia information service system.

In this embodiment, the media reader 2, or media device module, includes four card slots 210 and an interface controller module 22. Each of the card slots 210 receives an electronic card 3 therein and complies with a distinct specification. The interface controller module 22 is connected to the card slots 210 and reads information contained in the electronic cards 3.

The host unit 1 includes a controller 10 that is connected to the interface controller module 22, and that is operable so as to access the information read by the interface controller module 22.

In this embodiment, the interface controller module 22 converts the information read thereby into protocol-compliant information, which complies with a predetermined protocol, prior to access of the information by the controller 10 of the host unit 1.

The controller 10 of the host unit 1 is further operable so as to detect whether the interface controller module 22 is responding, and so as to issue a reset command to the interface controller module 22, which resets the interface controller module 22, when it is detected thereby that the interface controller module 22 stops responding.

It is noted that the interface controller module 22 for instance may stop responding, i.e., malfunction, when an electronic card 3 is improperly inserted into one of the card slots 210.

In this embodiment, the reset command issued by the controller 10 of the host unit 1 is a hard reset command, which resets the interface controller module 22 to factory settings.

Furthermore, in this embodiment, the controller 10 of the host unit 1 periodically detects whether the interface controller module 22 is responding. In particular, the host unit 1 further includes a timer 11 that is connected to the controller 10 thereof, and that is operable so as to determine predetermined time points at which the controller 10 of the host unit 1 detects whether the interface controller module 22 is responding.

The host unit 1 further includes an input module 12 and a display module 13, each of which is connected to the controller 10 thereof. The input module 12 accepts inputs from the user. The display module 13 displays information services accessible by the user.

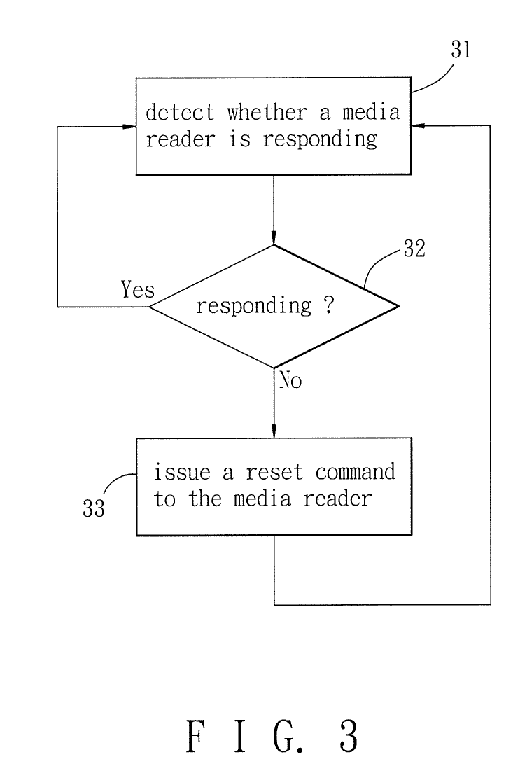

The preferred embodiment of a method of control in the aforementioned system 100 according to this invention will now be described with further reference to FIG. 3.

In step 31, the controller 10 of the host unit 1 is configured to periodically detect whether the interface controller module 22 of the media reader 2 is responding.

In this step, the controller 10 of the host unit 1 periodically sends a detecting signal to and detects a response from the interface controller module 22 of the media reader 2.

In step 32, when it is detected in step 31 that the interface controller module 22 of the media reader 2 stops responding, i.e., the controller 10 of the host unit 1 does not detect a response from the interface controller module 22 of the media reader 2, the flow proceeds to step 33. On the other hand, when the controller 10 of the host unit 1 detects the response from the interface controller module 22 of the media reader 2 indicating that the interface controller module 22 of the media reader 2 is functioning properly, the flow goes back to step 31.

In step 33, the controller 10 of the host unit 1 is configured to issue a reset command to the interface controller module 22 of the media reader 2. Thereafter, the flow goes back to step 31.

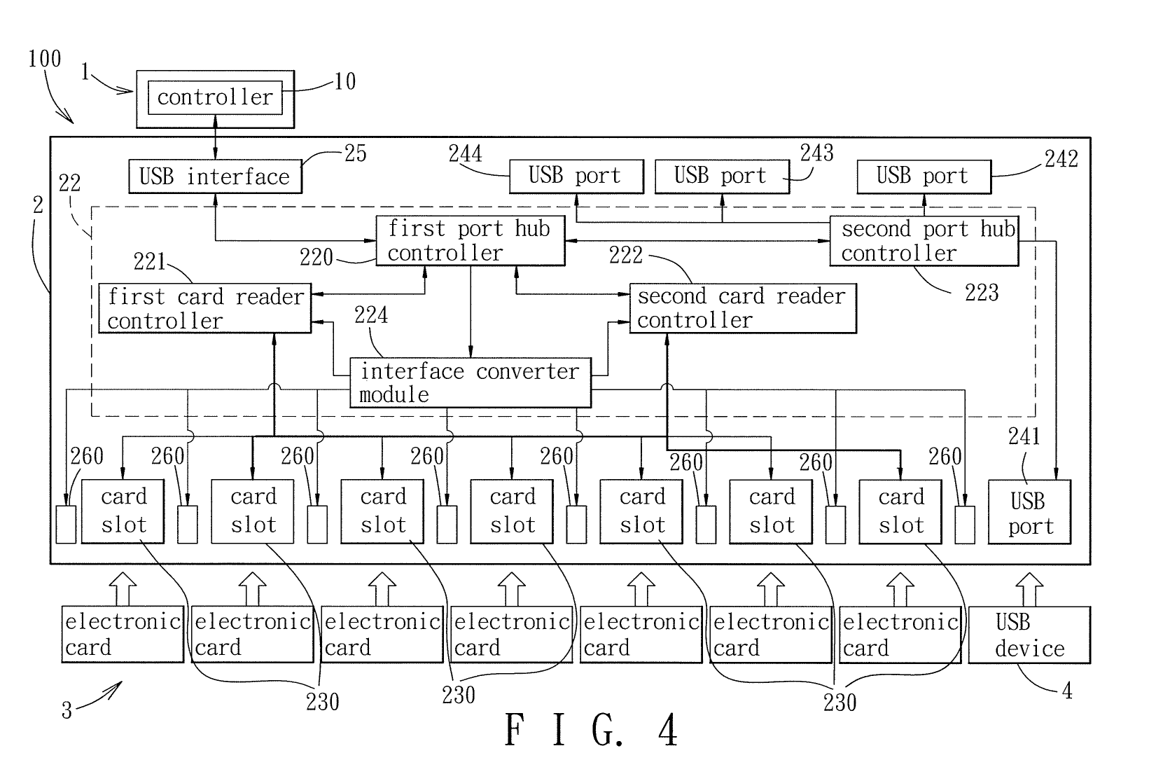

FIG. 4 illustrates the second preferred embodiment of a system 100 according to this invention. When compared to the previous embodiment, the media reader 2 includes seven card slots 230. In this embodiment, each of the card slots 230 complies with a specification established for a respective one of a mini secure digital (SD) card slot, a memory stick (MS) card slot, a memory stick micro (M2) card slot, a SD/multimedia card (SD/MMC) card slot, a compact flash (CF) card slot, an extreme digital (xD) card slot, and a micro SD card slot.

The interface controller module 22 of the media reader 2 includes first and second card reader controllers 221, 222, first and second port hub controllers 220, 223, and an interface converter module 224.

The first and second card reader controllers 221, 222 are connected to the card slots 230 and read information contained in each of the electronic cards 3 inserted in a corresponding one of the card slots 230. In this embodiment, each of the first and second card reader controllers 221, 222 is a RTS5181-type card reader controller.

The media reader 2 further includes a universal serial bus (USB) interface 25 connected to the controller 10 of the host unit 1.

The first port hub controller 220 is connected to the card reader controllers 221, 222, is coupled to the controller 10 of the host unit 1 through the USB interface 25, and forwards the information read by the first and second card reader controllers 221, 222 to the controller 10 of the host unit 1 through the USB interface 25.

In this embodiment, the first and second card reader controllers 221, 222 convert the information read thereby into protocol-compliant information, which complies with the USB protocol, prior to receipt of the information by the first port hub controller 220.

The controller 10 of the host unit 1 is further operable so as to detect whether the first/second card reader controller 221/222 is responding, and so as to issue a reset command to the first/second card reader controller 221/222 through the first port hub controller 220 to thereby reset the first/second card reader controller 221/222 when it is detected thereby that the first/second card reader controller 221/222 stops responding.

The interface converter module 224 is connected to the first port hub controller 220 and the first and second card reader controllers 221, 222, and converts the reset command from the first port hub controller 220, which complies with the USB protocol, into a reset signal, which complies with a general purpose input output (GPIO) protocol and which is subsequently provided to the first/second card reader controller 221, 222. In this embodiment, the interface converter module 224 is implemented using an 8051-type controller.

It is noted that the first or second card reader controller 221, 222 may stop responding when an electronic card 3 is improperly inserted into the corresponding card slot 230.

In this embodiment, the reset command issued by the controller 10 of the host unit 1 is a hard reset command, which resets the first/second card reader controller 221, 222 to factory settings.

The second port hub controller 223 is connected to the first port hub controller 220.

In this embodiment, each of the first and second port hub controllers 220, 223 is a 4-port hub controller.

The media reader 2 further includes four USB ports 241, 242, 243, 244 which are connected to the second port hub controller 223 and to which a USB device, e.g. the USB device 4, may be connected.

The second port hub controller 223 forwards USB protocol-compliant information from the USB device 4 to the controller 10 of the host unit 1 through the first port hub controller 220 and the USB interface 25.

The media reader 2 further includes eight indicator lamps 260, each of which is connected to the interface converter module 224 and corresponds to a respective one of the card slots 230 and the USB port 241. In this embodiment, the host unit 1 illuminates each indicator lamp 260 via the interface converter module 224 when the electronic card 3 is properly inserted into the corresponding card slot 230. Similarly, the host unit 1 illuminates the corresponding indicator lamp 260 via the interface converter module 224 when the USB device 4 is connected to the USB port 241.

It has thus been shown that the system 100 of this invention includes a media reader 2, and a host unit 1 that is connected to the media reader 2, that detects whether the media reader 2 is responding, and that resets the media reader 2 when it is detected thereby that the media reader 2 stops responding. As such, when the media reader 2 malfunctions, the media reader 2 is restored immediately to its normal condition without user intervention.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A method of control in a system that includes a media reader and a host unit, said method comprising:
A) configuring the host unit to detect whether the media reader is responding; and
B) configuring the host unit to reset the media reader when it is detected in step A) that the media reader stops responding.

2. The method as claimed in claim 1, wherein step A) is performed periodically.

3. The method as claimed in claim 1, wherein, in step B), the host unit issues a hard reset command to the media reader.

4. A system, comprising:
a media reader; and
a host unit coupled to said media reader, and operable so as to detect whether said media reader is responding, and so as to issue a reset command to said media reader, which resets said media reader, when it is detected thereby that said media reader stops responding.

5. The system as claimed in claim 4, wherein said media reader includes
a card slot which is adapted to receive an electronic card therein, and
an interface controller module which is coupled to said card slot and which is adapted to read information contained in the electronic card,
said host unit being coupled to said interface controller module, detecting a response from said interface controller module, and issuing the reset command to said interface controller module,
said host unit being further operable so as to access the information read by said interface controller module.

6. The system as claimed in claim 5, wherein said interface controller module converts the information read thereby into protocol-compliant information, which complies with a predetermined protocol, prior to access of the information by said host unit.

7. The system as claimed in claim 4, wherein said media reader includes
a card slot which is adapted to receive an electronic card therein,
a card reader controller which is coupled to said card slot and which is adapted to read information contained in the electronic card, and
a port hub controller which is coupled to said card reader controller and said host unit, which forwards the information read by said card reader controller to said host unit, and through which said host unit detects a response from and issues the reset command to said card reader controller.

8. The system as claimed in claim 7, wherein said media reader further includes an interface through which said host unit is coupled to said port hub controller and which complies with a predetermined protocol,
said card reader controller converting the information read thereby into protocol-compliant information, which complies with the predetermined protocol, prior to receipt of the information by said port hub controller.

9. The system as claimed in claim 7, wherein said port hub controller complies with a first predetermined protocol, and said card reader controller complies with a second predetermined protocol,
said media reader further including an interface converter module coupled between said port hub controller and said card reader controller,
said interface converter module converting the reset command from said port hub controller, which complies with the first predetermined protocol, into a reset signal, which complies with the second predetermined protocol and which is subsequently provided to said card reader controller.

10. The system as claimed in claim 7, wherein said port hub controller complies with a USB protocol, and said card reader controller complies with a general purpose input output (GPIO) protocol,
said media reader further including an interface converter module coupled between said port hub controller and said card reader controller,
said interface converter module converting the reset command from said port hub controller, which complies with the USB protocol, into a reset signal, which complies with the GPIO protocol and which is subsequently provided to said card reader controller.

11. The system as claimed in claim 7, wherein each of said card reader controller and said port hub controller complies with a universal serial bus (USB) protocol.

12. The system as claimed in claim 7, wherein said media reader further includes an indicator lamp that illuminates when said card slot properly receives the electronic card therein.

13. The system as claimed in claim 4, wherein said host unit is further operable so as to determine predetermined time points at which said host unit detects whether said media reader is responding.

14. The system as claimed in claim 4, wherein the reset command issued by said host unit is a hard reset command.
